(19) United States
(12) Patent Application Publication
(10) Pub. No.: US 2019/0390694 A1
(43) Pub. Date: Dec. 26, 2019

(54) POOL DECK ANCHOR

(71) Applicant: SMARTPOOL LLC, Lakewood, NJ (US)

(72) Inventor: Ariyeh Leib Green, Wilton Manors, FL (US)

(73) Assignee: SMARTPOOL LLC, Lakewood, NJ (US)

(21) Appl. No.: 16/017,540

(22) Filed: Jun. 25, 2018

(51) Int. Cl. F16B 5/07

(52) U.S. Cl. CPC F16B 5/07; E04H 4/06

(57) ABSTRACT

An anchor for securing either a safety cover or safety net relative to a swimming pool that includes a fitting having a first end and a second end with an elongated internally threaded opening extending from the first end towards the second end. A screw includes a first end and a second end, the screw is externally threaded wherein the first end thereof is received within the elongated internally threaded opening in the fitting to be selectively screwed within the fitting to a predetermined depth and to be selectively unscrewed from the fitting to extend a predetermined height above the first end of the fitting. A head portion is formed on the second end of the screw and includes a flange extending substantially around an outer surface of the head portion with an opening formed in the head portion for selectively securing a hook relative to the head portion.

### BACKGROUND OF THE INVENTION

### Field of the Invention

The present invention relates to a pool deck anchor that can be used to secure either a safety cover by use of a spring attached to the safety cover or a safety net by use of a hook attached to the safety net.

### Description of Background Art

A conventional safety cover pool deck anchor consists of a brass fitting that is embedded or mounted in a deck surface surrounding a pool with the top surface of the safety cover pool deck anchor being flush with the deck surface. The brass fitting includes an internally threaded opening with an externally threaded screw that is threaded within the internally threaded opening. The screw may be selectively, manually unscrewed relative to the fitting to extend the screw a predetermined height above the top surface of the brass fitting. When the screw is extended relative to the brass fitting, a spring member may be positioned on the extended portion of the screw to permit a safety pool cover to be tightly secured over the top of a swimming pool in the winter time.

A conventional safety net pool deck anchor consists of a hook with an enlarged first end for inserting into an enlarged opening on the top of a brass fitting that is embedded or mounted in a deck surface surrounding a pool with the top surface of the safety net pool deck anchor being flush with the deck surface. Thereafter, the enlarged first end is slid into a narrower opening to secure the hook relative to the brass fitting. When the enlarged first end of the hook is secured in the narrower opening in the brass fitting, a second end of the hook may be secured to the safety net to permit the safety net to be secured over the top of a swimming pool.

However, the two conventional anchors are required to be separately embedded or mounted in a deck surface.

### SUMMARY AND OBJECTS OF THE INVENTION

The present invention has been made in consideration of the foregoing circumstances.

An object of an embodiment of the present invention is to provide an anchor for securing either a safety cover or safety net relative to a swimming pool that includes a fitting that is embedded or mounted in a deck surface. The fitting includes a first end and a second end with an elongated internally threaded opening extending from the first end towards the second end. A screw includes a first end and a second end. The screw is externally threaded wherein the first end thereof is received within the elongated internally threaded opening in the fitting to be selectively screwed within the fitting to a predetermined depth and to be selectively unscrewed from the fitting to extend a predetermined height above the first end of the fitting. A head portion is formed on the second end of the screw. The head portion includes a flange extending substantially around an outer surface of the head portion with an opening formed in the head portion for selectively securing a hook relative to the head portion. When the screw is selectively unscrewed a predetermined height above the first end of the fitting, the extended portion is adapted to be secured to a spring member for mounting a swimming pool safety cover relative to a swimming pool and the opening in the top portion of the head is adapted to secure a hook for mounting a swimming pool safety net relative to the swimming pool.

According to an embodiment of the present invention, the anchor for securing either a safety cover or a safety net relative to a swimming pool includes a key hole like opening having an enlarged portion for receiving the enlarged outer end of the hook and a narrower portion attached to the enlarged portion for receiving a reduced section of the hook and for retaining the enlarged section of the hook within the narrower portion.

According to an embodiment of the present invention, the anchor for securing either a safety cover or a safety net relative to a swimming pool includes a flange that extends around an outer circumferential surface of the head portion of the screw and extends outwardly from the head portion of the screw.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an elevational cut away view illustrating the internally threaded fitting and the externally threaded screw of the present invention;

FIG. 2 is a top plan view illustrating the opening in the head portion;

FIG. 3 is a perspective cut away view illustrating the screw being unscrewed a predetermined height above the fitting for securing a spring member thereto; and

FIG. 4 is a partial perspective view of the head portion including a key hole like opening for inserting an enlarged portion of a hook therein and for retaining the enlarged portion of the hook within the narrower portion thereof.

### DETAILED DESCRIPTION OF THE PREFERRED EMBODIMENTS

Hereinbelow, an embodiment of the present invention will be described.

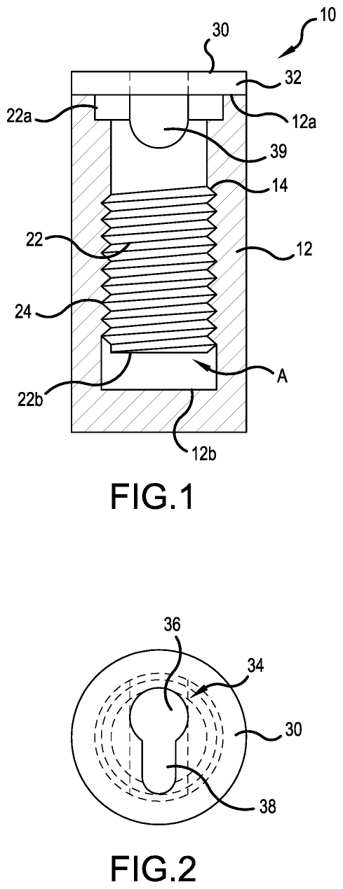

As illustrated in FIGS. 1-3, an anchor 10 is provided for securing either a safety cover or a safety net relative to a swimming pool. The anchor 10 includes a fitting 12 embedded or mounted in a deck surface. The fitting 12 includes a first end 12a and a second end 12b with an elongated internally threaded opening 14 extending from the first end 12a towards the second end 12b.

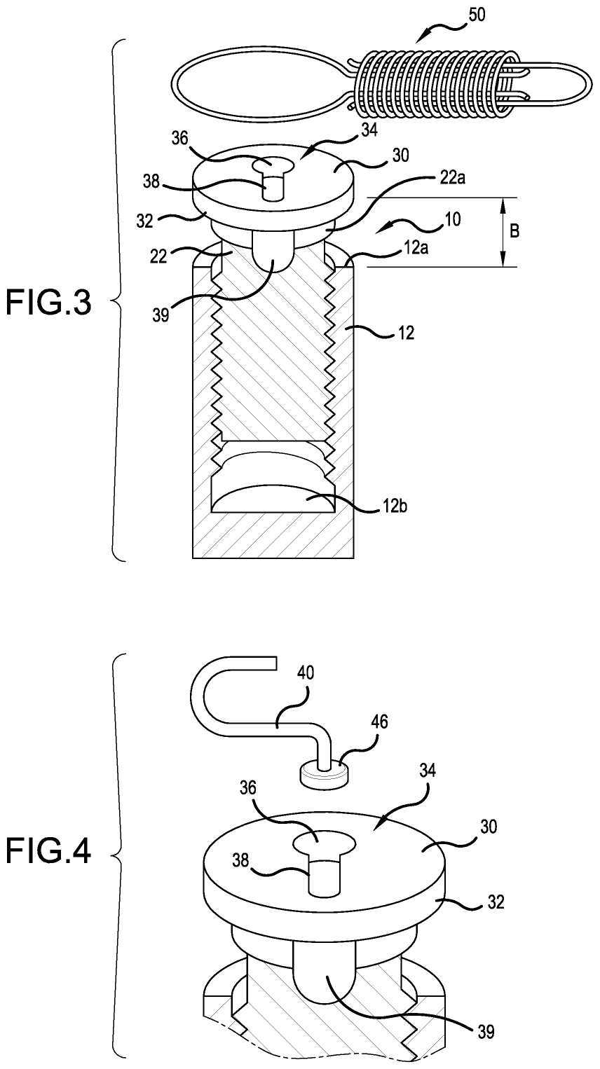

In addition, the anchor 10 includes a screw 22 having a first end 22a and a second end 22b. The screw 22 is externally threaded 24 wherein the second end 22b thereof is received within the elongated internally threaded opening 14 in the fitting 12 to be selectively screwed within the fitting 12 to a predetermined depth A. As illustrated in FIG. 3, the screw 22 may be selectively unscrewed from the fitting 12 to extend a predetermined height B above the first end 12a of the fitting 12.

As illustrated in FIGS. 1-4, a head portion 30 is formed on the first end 22a of the screw 22. The head portion 30 including a flange 32 extending substantially around an outer surface of said head portion 30. In addition, the head portion 30 includes an opening 34 formed in the head portion 30 for selectively securing a hook 40 relative to the head portion 30.

As illustrated in FIGS. 2-4, the opening 34 in the top portion of the head portion 30 is a key hole like opening having an enlarged opening portion 36 for receiving an enlarged outer end 46 of the hook 40 and a narrower portion 38 attached to the enlarged portion for receiving a reduced section of the hook 40 and for retaining the enlarged outer end 46 of the hook 40 within the narrower portion 38. As illustrated in FIGS. 1, 3 and 4, the opening 34 includes a recessed portion 39 extending through the screw 22 for receiving the enlarged outer end 46 when the hook 40 is inserted into the enlarged opening portion 36 and slid towards the narrower portion 38.

As illustrated in FIG. 3, when the screw 22 is selectively unscrewed a predetermined height B above the first end 12a of the fitting 12, the flange 32 is positioned above the first end 12a and the portion of the screw 22 projecting above the first end 12a of the fitting 12 may be secured to a spring member 50 for retaining a swimming pool safety cover relative to a swimming pool.

As illustrated in FIG. 4, when the screw 22 is within the fitting 12, the opening 34 in the top portion of the head 30 may receive the enlarged outer end 46 of the hook 40 into the enlarged opening portion 36 of the opening 34. Thereafter, the hook 40 is slid into the narrower portion 38 wherein the enlarged outer end 46 of the hook 40 is received within the recessed portion 39 in the screw 22. In this way, the hook 40 may be used to secure a pool safety net relative to a swimming pool.

In a preferred embodiment of the present invention, the flange 32 may extend around an outer circumferential surface of the head portion 30 of the screw 22 and extends outwardly from the head portion of the screw 22. In this way, when a spring member 50 is mounted on the portion of the screw that extends above the fitting 12 a predetermined distance B, the flange or lip 32 will ensure that the spring member 50 is not disengaged from the screw 22 during use of the spring member 50 to mount the swimming pool safety cover relative to the swimming pool.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An anchor for securing either a safety cover or a safety net relative to a swimming pool comprising:
a fitting having a first end and a second end with an elongated internally threaded opening extending from the first end towards the second end;
a screw having a first end and a second end, said screw being externally threaded wherein the first end thereof is received within the elongated internally threaded opening in the fitting to be selectively screwed within the fitting to a predetermined depth and to be selectively unscrewed from the fitting to extend a predetermined height above the first end of the fitting; and
a head portion formed on the second end of the screw, said head portion including:
a flange extending substantially around an outer surface of said head portion; and
an opening formed in a top portion of the head portion for selectively securing a hook relative to the head portion,
wherein when said screw is selectively unscrewed a predetermined height above the first end of the fitting, the screw is adapted to be secured to a spring member for a swimming pool safety cover and the opening in the top portion of the head of the screw is adapted to secure a hook for a swimming pool safety net.

2. The anchor for securing either a safety cover or a safety net relative to a swimming pool according to claim 1, wherein the opening in the top portion of the head is a key hole like opening having an enlarged portion for receiving an enlarged outer end of a hook and a narrower portion attached to the enlarged portion for receiving a reduced section of the hook and for retaining the enlarged section of the hook within the narrower portion.

3. The anchor for securing either a safety cover or a safety net relative to a swimming pool according to claim 1, wherein the flange extends around an outer circumferential surface of the head portion of the screw and extends outwardly from the head portion of the screw.

4. The anchor for securing either a safety cover or a safety net relative to a swimming pool according to claim 1, and further including a recessed portion formed in the head portion of the screw for accommodating an enlarged end portion of a hook when a hook is secured relative to the head portion of the screw.

5. The anchor for securing either a safety cover or a safety net relative to a swimming pool according to claim 4, wherein the recessed portion extends through the head portion of the screw to accommodate the enlarged end portion of the hook when it is first positioned within an enlarged opening in the head portion of the screw and for securing the enlarged end portion of the hook when it is slid into a narrower portion formed on the head portion of the screw.

6. An anchor for securing either a safety cover or a safety net relative to a swimming pool comprising:
a fitting having a first end and a second end with an elongated internally threaded opening extending from the first end towards the second end;
a screw having a first end and a second end, said screw being externally threaded wherein the first end thereof is received within the elongated internally threaded opening in the fitting to be selectively screwed within the fitting to a predetermined depth and to be selectively unscrewed from the fitting to extend a predetermined height above the first end of the fitting; and
a head portion formed on the second end of the screw, said head portion including an opening formed in a top portion of the head portion for selectively securing a hook relative to the head portion,
wherein when said screw is selectively unscrewed a predetermined height above the first end of the fitting, the screw is adapted to be secured to a spring member for a swimming pool safety cover and the opening in the top portion of the head of the screw is adapted to secure a hook for a swimming pool safety net.

7. The anchor for securing either a safety cover or a safety net relative to a swimming pool according to claim 6, wherein the opening in the top portion of the head is a key hole like opening having an enlarged portion for receiving an enlarged outer end of a hook and a narrower portion attached to the enlarged portion for receiving a reduced section of the hook and for retaining the enlarged section of the hook within the narrower portion.

8. The anchor for securing either a safety cover or a safety net relative to a swimming pool according to claim 6, and further including a flange that extends around an outer circumferential surface of the head portion of the screw and extends outwardly from the head portion of the screw.

9. The anchor for securing either a safety cover or a safety net relative to a swimming pool according to claim 6, and further including a recessed portion formed in the head portion of the screw for accommodating an enlarged end portion of a hook when a hook is secured relative to the head portion of the screw.

10. The anchor for securing either a safety cover or a safety net relative to a swimming pool according to claim 9, wherein the recessed portion extends through the head portion of the screw to accommodate the enlarged end portion of the hook when it is first positioned within an enlarged opening in the head portion of the screw and for securing the enlarged end portion of the hook when it is slid into a narrower portion formed on the head portion of the screw.

11. The anchor for securing either a safety cover or a safety net relative to a swimming pool according to claim 6, and further including a flange extending substantially around an outer surface of said head portion.
